(19) United States
(12) Patent Application Publication
(10) Pub. No.: US 2025/0335823 A1
(43) Pub. Date: Oct. 30, 2025

(54) INFORMATION PROCESSING APPARATUS, INFORMATION PROCESSING METHOD, AND SERVER

(71) Applicant: NEC Corporation, Tokyo (JP)

(72) Inventors: Junki MORI, Tokyo (JP); Toshinori ARAKI, Tokyo (JP); Isamu TERANISHI, Tokyo (JP); Kazuya KAKIZAKI, Tokyo (JP); Kunihiro ITO, Tokyo (JP); Yuto MATSUNAGA, Tokyo (JP); Kosuke KIHARA, Tokyo (JP); Ryo FURUKAWA, Tokyo (JP); Taiki MIYAGAWA, Tokyo (JP)

(73) Assignee: NEC Corporation, Tokyo (JP)

(21) Appl. No.: 19/089,056

(22) Filed: Mar. 25, 2025

(30) Foreign Application Priority Data
Apr. 25, 2024 (JP) 2024-071275

(51) Int. Cl. G06N 20/00; H04L 9/40

(52) U.S. Cl. CPC G06N 20/00; H04L 63/04

(57) ABSTRACT

Provided is an information processing apparatus including: a learning unit configured to perform machine learning of a language model; a generation unit configured to generate a reply to reference data received from a server using the language model; and a concealment unit configured to transmit, to the server, a concealed reply in which information of a specific type in the reply is concealed, wherein the learning unit learns the language model based on combination data of the reference data and replies generated for the reference data by other information processing apparatuses, the replies being received from the server.

### INCORPORATION BY REFERENCE

This application is based upon and claims the benefit of priority from Japanese patent application No. 2024-071275, filed on Apr. 25, 2024, the disclosure of which is incorporated herein in its entirety by reference.

### TECHNICAL FIELD

The present disclosure relates to an information processing apparatus, an information processing method, and a server.

### BACKGROUND ART

Japanese Unexamined Patent Application Publication No. 2022-177828 describes that federated learning (FL) provides a collaborative training mechanism which allows multiple parties to build a machine learning (ML) model together. It is also described that the federated learning allows the respective parties to retain private data within their trusted and protected domains/infrastructures, instead of pooling all pieces of training data in an aggregation server (or datacenter).

It is also described that each of the parties trains a local model and only uploads model updates or gradients to the aggregation server. It is also described that such an aggregator fuses the model updates and broadcasts the aggregated model back to all the parties for model synchronization.

### SUMMARY

In the technique described in Patent Literature 1, however, there is a possibility that learning data (training data) in each client (each party) leaks from a model (local model) generated by machine learning in each client.

In view of the above-described problem, an example object of the present disclosure is to provide a technique for improving computer security related to an information processing apparatus such as a client.

In a first aspect according to the present disclosure, there is provided an information processing apparatus including: a learning unit configured to perform machine learning of a language model; a generation unit configured to generate a reply to reference data received from a server using the language model; and a concealment unit configured to transmit, to the server, a concealed reply in which information of a specific type in the reply is concealed, wherein the learning unit learns the language model based on combination data of the reference data and replies generated for the reference data by other information processing apparatuses, the replies being received from the server.

In a second aspect according to the present disclosure, there is provided an information processing method including: performing machine learning of a language model; generating a reply to reference data received from a server using the language model; transmitting, to the server, a concealed reply in which information of a specific type in the reply is concealed; and learning the language model based on combination data of the reference data and replies generated for the reference data by other information processing apparatuses, the replies being received from the server.

In a third aspect according to the present disclosure, there is provided a program for causing a computer to execute processing including: performing machine learning of a language model; generating a reply to reference data received from a server using the language model; transmitting, to the server, a concealed reply in which information of a specific type in the reply is concealed; and learning the language model based on combination data of the reference data and replies generated for the reference data by other information processing apparatuses, the replies being received from the server.

In a fourth aspect according to the present disclosure, there is provided a server including: a transmission unit configured to transmit reference data to a plurality of information processing apparatuses; an acquisition unit configured to acquire, from each of the plurality of information processing apparatuses, a reply to the reference data or a concealed reply in which information of a specific type in the reply is concealed, the reply being generated using a machine-learned language model; and a specification unit configured to specify a first reply among a plurality of the replies acquired by the acquisition unit, wherein the transmission unit transmits information for learning of the language model to the plurality of information processing apparatuses based on combination data of the first reply and the reference data.

In a fifth aspect according to the present disclosure, there is provided an information processing system including a server and a plurality of information processing apparatuses, wherein each of the plurality of information processing apparatuses includes: a learning unit configured to perform machine learning of a language model; a generation unit configured to generate a reply to reference data received from the server using the language model; and a concealment unit configured to transmit, to the server, a concealed reply in which information of a specific type in the reply is concealed, the learning unit learns the language model based on combination data of the reference data and replies generated for the reference data by the other information processing apparatuses, the replies being received from the server, the server includes: a transmission unit configured to transmit the reference data to the plurality of information processing apparatuses; an acquisition unit configured to acquire, from each of the plurality of information processing apparatuses, the reply to the reference data or the concealed reply in which the information of the specific type in the reply is concealed, the reply being generated using the machine-learned language model; and a specification unit configured to specify a first reply among a plurality of the replies acquired by the acquisition unit, and the transmission unit transmits information for learning of the language model to the plurality of information processing apparatuses based on combination data of the first reply and the reference data.

According to one aspect, it is possible to improve the computer security related to the information processing apparatus such as a client.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of a configuration of an information processing apparatus according to an example embodiment;

FIG. 2 is a diagram illustrating a configuration example of an information processing system according to an example embodiment;

FIG. 3 is a diagram illustrating a hardware configuration example of the information processing apparatus according to the example embodiment; and

FIG. 4 is a sequence diagram illustrating an example of processing in the information processing system according to the example embodiment.

### EXAMPLE EMBODIMENTS

The principles of the present disclosure will be described with reference to several example embodiments. It is to be understood that the example embodiments have been described for purposes of illustration only and will aid those skilled in the art in understanding and carrying out the present disclosure without suggesting limitations on the scope of the present disclosure. The disclosure described in the present specification is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present disclosure will be described with reference to the drawings. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Example Embodiment

### <Configuration>

### <<Configuration of Information Processing Apparatus 10>>

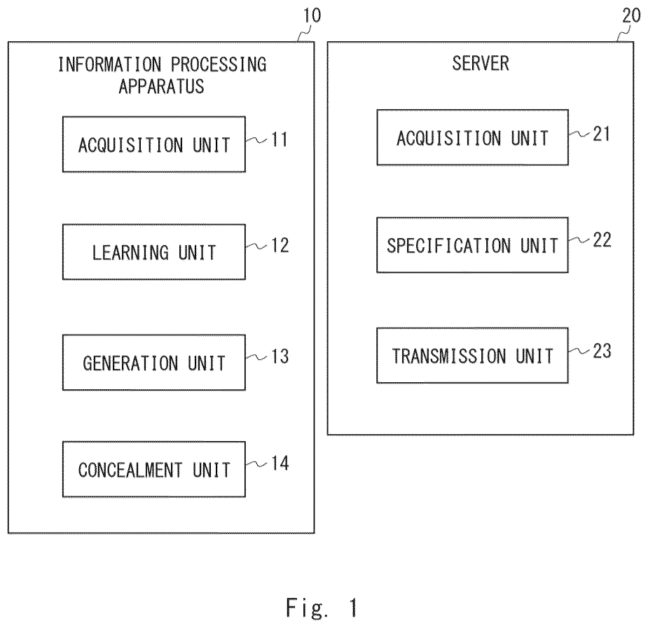

Configurations of an information processing apparatus 10 and a server 20 according to an example embodiment will be described with reference to FIG. 1. FIG. 1 is a diagram illustrating an example of the configurations of the information processing apparatus 10 and the server 20 according to the example embodiment. The information processing apparatus 10 includes an acquisition unit 11, a learning unit 12, a generation unit 13, and a concealment unit 14. These units may be implemented by cooperation of one or more programs installed in the information processing apparatus 10 and hardware such as a processor and a memory of the information processing apparatus 10. The information processing apparatus 10 may also be referred to as an agent, a learning agent, or a client.

The acquisition unit 11 acquires local data. The learning unit 12 performs machine learning of a large-scale language model based on the local data acquired by the acquisition unit 11. In addition, the learning unit 12 learns the large-scale language model again based on combination data of reference data and replies generated for the reference data by other information processing apparatuses, the replies being received from the server. The local data represents data stored in the information processing apparatus (or agent or client). The local data represents, for example, data that is not shared among a plurality of information processing apparatuses. The large-scale language model is, for example, a language model implemented by a multilayer neural network, and may be a model implemented by a transformer. The language model represents, for example, a model that receives input of a question (or instruction) indicated by a text described in a natural language and outputs an answer (or reply) to the question (or instruction). The language model may be, for example, a model that outputs image data with respect to an input indicated by the image data. The language model may be, for example, a model that outputs image data with respect to an input indicated by a text described in a natural language. The language model is not limited to the above examples. Hereinafter, for convenience of description, the “language model” including the above concepts will be described.

The generation unit 13 generates a reply to data (hereinafter described as “reference data”) received from the server 20 using the language model generated by the learning unit 12. In a case where the reply generated by the generation unit 13 includes information of a specific type, the concealment unit 14 transmits, to the server 20, a replay in which the information of the specific type in the reply is concealed. Information of the specific type represents data (or data to be concealed) to be kept secret from the outside of the information processing apparatus 10, such as personal information, in-house information, and non-public information.

### <<Configuration of Server 20>>

The server 20 includes an acquisition unit 21, a specification unit 22, and a transmission unit 23. These units may be implemented by cooperation of one or more programs installed in the server 20 and hardware such as a processor and a memory of the server 20.

The acquisition unit 21 acquires, from each of a plurality of the information processing apparatuses 10, a reply to reference data generated using a language model machine-learned based on local data, or a concealed reply in which information of a specific type in the reply is concealed.

The specification unit 22 specifies a reply (hereinafter, described as a “first reply”) used for learning of the language model among the replies acquired by the acquisition unit 21. The transmission unit 23 transmits the reference data to the plurality of information processing apparatuses 10. In addition, the transmission unit 23 transmits information to be used for learning of the language model to the plurality of information processing apparatuses 10 based on data including a combination of the first reply specified by the specification unit 22 and the reference data.

### Second Example Embodiment

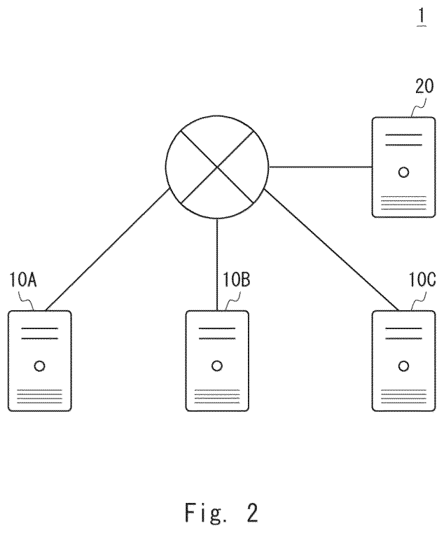

Next, a configuration of an information processing system 1 according to an example embodiment will be described with reference to FIG. 2.

### <System Configuration>

FIG. 2 is a diagram illustrating a configuration example of the information processing system 1 according to the example embodiment. In the example of FIG. 2, the information processing system 1 includes a plurality of the information processing apparatuses 10 (information processing apparatuses 10A to 10C) and the server 20. In the example of FIG. 2, the respective information processing apparatuses 10 and the server 20 are connected so as to be able to communicate with each other via a network N. Note that the number of the information processing apparatuses 10 and the number of the servers 20 are not limited to those in the example of FIG. 2.

Examples of the network N include the Internet, a mobile communication system, a wireless local area network (LAN), a LAN, and a bus. Examples of the mobile communication system include a fifth generation mobile communication system (5G), a sixth generation mobile communication system (6G and Beyond 5G), a fourth generation mobile communication system (4G), and a third generation mobile communication system (3G).

The information processing apparatus 10 may be, for example, an apparatus such as a server, a cloud server, or a personal computer. The information processing apparatus 10 may be operated by, for example, an administrator of each base, each business operator, or the like. The information processing apparatus 10 learns the language model based on, for example, local data that is non-public text (sentence) data including confidential information, personal information, and the like managed by a specific base or business operator. In addition, the information processing apparatus 10 transmits the reply to the reference data, received from the server 20, to the server 20 using the language model based on the local data. In addition, the information processing apparatus 10 receives, from the server 20, the replies to the reference data by the other information processing apparatuses 10 received from the server 20. In addition, the information processing apparatus 10 learns the language model again based on the replies and the reference data received from the server 20.

The server 20 may be, for example, an apparatus such as a server, a cloud server, or a personal computer. The server 20 may be operated by, for example, an administrator of the entire system. The server 20 causes the plurality of information processing apparatuses 10 to perform machine learning in cooperation.

### <Hardware Configuration>

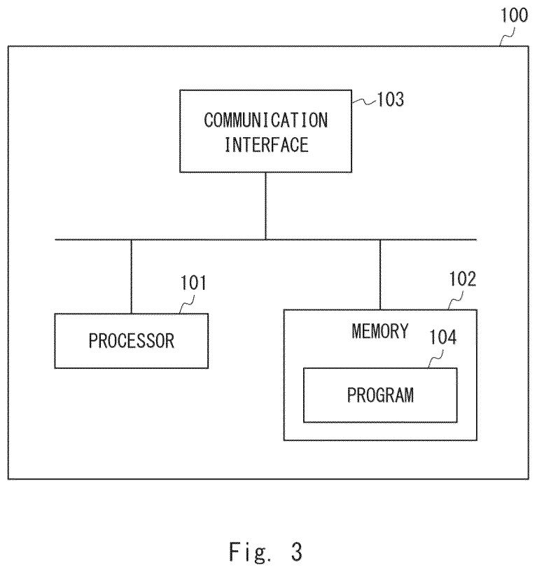

FIG. 3 is a diagram illustrating a hardware configuration example of the information processing apparatus 10 according to the example embodiment. In the example of FIG. 3, the information processing apparatus 10 (a computer 100) includes a processor 101, a memory 102, and a communication interface 103. These units may be connected by a bus or the like. The memory 102 stores at least a part of a program 104. The communication interface 103 includes an interface necessary for communication with other network elements.

When the program 104 is executed by the cooperation of the processor 101, the memory 102, and the like, at least a part of processing according to the example embodiment of the present disclosure is performed by the computer 100. The memory 102 may be of any type. The memory 102 may be a non-transitory computer-readable storage medium, as a non-limiting example. In addition, the memory 102 may also be implemented using any suitable data storage technique such as a semiconductor-based memory device, a magnetic memory device and system, an optical memory device and system, a fixed memory, or a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a digital signal processor (DSP), and a processor based on a multi-core processor architecture as a non-limiting example. The computer 100 may include a plurality of processors such as application specific integrated circuit chips that are temporally dependent on a clock that synchronizes the main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor or other computing devices.

The present disclosure also provides at least one computer program product tangibly stored on a non-transitory computer-readable storage medium. The computer program product includes computer-executable instructions, such as those included in a program module, and is executed on a device on a target real or virtual processor to perform the processes or methods of the present disclosure. The program module includes routines, programs, libraries, objects, classes, components, data structures, and the like that execute particular tasks or implement particular abstract data types. Functions of the program module may be combined or divided between the program modules as desired in various example embodiments. A machine-executable instruction of the program module can be executed in a local or distributed device. In the distributed device, the program modules can be located on both local and remote storage media.

Program codes for executing the methods of the present disclosure may be written in any combination of one or more programming languages. These program codes are provided to a processor or controller of a general purpose computer, a dedicated computer, or other programmable data processing apparatuses. When the program code is executed by the processor or controller, the functions/operations in the flowcharts and/or the implemented block diagrams are performed. The program code is executed entirely on a machine, partially on the machine as a stand-alone software package, partially on the machine and partially on a remote machine, or entirely on the remote machine or server.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

### <Processing>

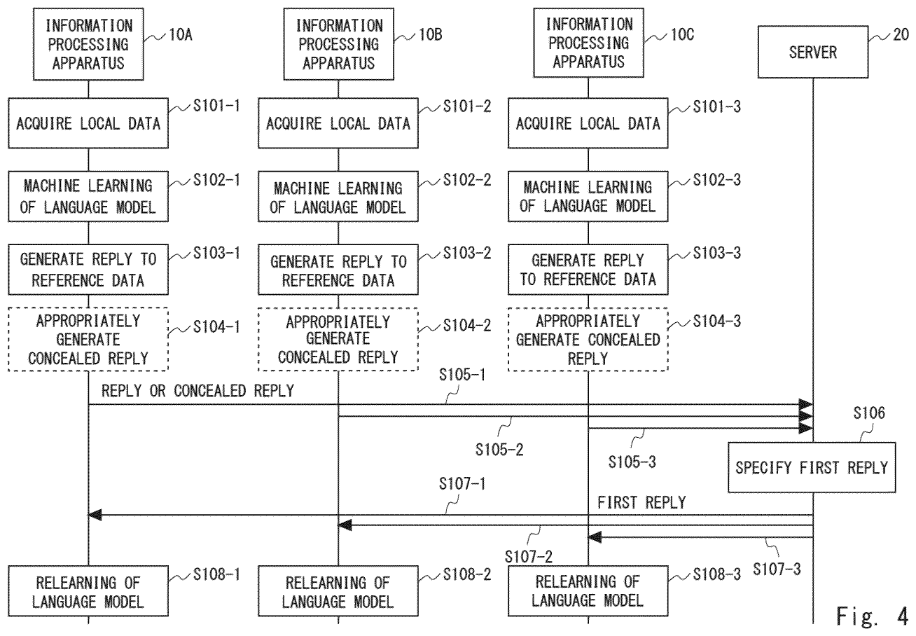

Next, an example of processing in the information processing system 1 according to the example embodiment will be described with reference to FIG. 4. FIG. 4 is a sequence diagram illustrating the example of the processing in the information processing system 1 according to the example embodiment. Note that the following processing can be executed in an appropriately changed order as long as there is no contradiction.

In steps S101-1 to S101-3, the acquisition unit 11 of each of the information processing apparatuses 10 acquires local data. Here, the respective information processing apparatuses 10 may acquire pieces of local data different from each other. The local data may be, for example, non-public text (sentence) data including confidential information, personal information, and the like managed by each of the information processing apparatuses 10 (for example, a specific base or business operator). Note that the local data in the present disclosure may be, for example, data related to medical care, finance, manufacturing, research and development, a trial, or the like. More specifically, examples of the local data may include data indicating a symptom and the like described in a medical chart or the like, data regarding a bank loan, data including personal data of an insurance subscriber, an internal manual, confidential information regarding development, and confidential information regarding a trial and the like.

Next, the learning unit 12 of each of the information processing apparatuses 10 performs machine learning of a language model based on the local data acquired by the acquisition unit 11 of each of the information processing apparatuses 10 (steps S102-1 to S102-3). Here, for example, the learning unit 12 may perform self-supervised learning or semi-supervised learning using the local data that is unlabeled text data. The language model may be, for example, a learned model that uses a sentence as an input and predicts (infers, estimates, or outputs) a word following the input sentence and a probability that the word follows the input sentence. In this case, the learning unit 12 may generate the language model by, for example, bidirectional encoder representations from transformers (BERT), a generative pre-trained transformer (GPT), or the like.

The generation unit 13 of each of the information processing apparatuses 10 generates a reply to reference data received from the server 20 using the language model generated by the learning unit 12 of each of the information processing apparatuses 10 (steps S103-1 to S103-3). Here, the reference data may be, for example, text data published on the Internet or the like. In addition, the reply may be, for example, a word or the like estimated to follow a sentence included in the reference data. In this case, for example, the generation unit 13 may use the sentence included in the reference data as an input and predict the word following the input sentence and a probability (reliability) that the word follows the input sentence. The generation unit 13 may generate a plurality of replies having different reliabilities, and output a specific number of combinations of replies and reliability values in descending order of the reliability. In addition, in a case where the reply is a sentence including a plurality of words, the generation unit 13 may output a product of generation probabilities of the respective words as the reliability.

Next, in a case where the reply generated by the generation unit 13 of each of the information processing apparatuses 10 includes information of a specific type, the concealment unit 14 of each of the information processing apparatuses 10 generates a concealed reply in which the information of the specific type in the reply is concealed (steps S104-1 to S104-3). Here, for example, the concealment unit 14 may generate the concealed reply by replacing the information of the specific type included in the reply having the highest reliability with other information (for example, a masking character with a symbol such as O, or another word such as “Jiro Tanaka” for “Taro Yamada”).

In addition, the concealment unit 14 may determine a second reply as the concealed reply in a case where the generation unit 13 generates a first reply including information of a specific type and having a first reliability and the second reply not including information of the specific type and having a second reliability lower than the first reliability. In this case, for example, the concealment unit 14 may determine (select) a reply with the highest reliability out of one or more replies not including information of the specific type and generated by the generation unit 13 as the concealed reply. In this case, for example, the concealment unit 14 may determine whether each reply with each reliability generated by the generation unit 13 corresponds to information of the specific type in descending order of the reliability. Then, the concealment unit 14 may determine one having the highest reliability among replies not corresponding to information of the specific type as the concealed reply.

Information of the specific type may be, for example, confidential information, personal information, or the like. The concealment unit 14 may determine whether each word included in a reply is information of the specific type using, for example, artificial intelligence (AI) or the like. In addition, the concealment unit 14 may determine whether each word included in a reply is information of the specific type based on a list of words set (registered) in advance in the information processing apparatus 10 by an operator (administrator) or the like, for example. Note that the concealment unit 14 does not generate the concealed reply when the reply generated by the generation unit 13 of each of the information processing apparatuses 10 does not include information of the specific type.

Next, the concealment unit 14 transmits a reply or a concealed reply to the server 20 (steps S105-1 to S105-3). Here, in a case where the reply does not include information of the specific type, the concealment unit 14 transmits the reply generated by the generation unit 13 to the server 20. On the other hand, in a case where the reply generated by the generation unit 13 includes information of the specific type, the concealment unit 14 transmits, to the server 20, the concealed reply in which the information of the specific type in the reply is replaced with a masking character or the like.

Here, in a case where a reply with the highest reliability generated by the generation unit 13 does not include information of the specific type, the concealment unit 14 may transmit the reply and the reliability (first reliability) of the reply to the server 20. In addition, for example, in a case where the reply with the highest reliability generated by the generation unit 13 includes information of the specific type, the concealment unit 14 may transmit the concealed reply and the second reliability lower than the first reliability to the server 20. Here, in a case where the concealed reply is a reply with the highest reliability out of one or more replies not corresponding to information of the specific type and generated by the generation unit 13, the second reliability may be a reliability of the reply.

In addition, in a case where the concealed reply is obtained by replacing information of the specific type included in the reply with the highest reliability with other information, the concealment unit 14 may determine the second reliability to be a value lower than the first reliability which is the reliability of the reply. As a result, for example, it is possible to reduce a case where the concealed reply is determined as a reply for learning in the server 20.

Next, the specification unit 22 of the server 20 specifies a first reply among replies from the respective information processing apparatuses 10 (step S106). Here, for example, the specification unit 22 may specify a reply with the highest reliability out of a third reply generated with a third reliability by the information processing apparatus 10B (an example of a “first information processing apparatus”) and a fourth reply generated with a fourth reliability by the information processing apparatus 10C (an example of a “second information processing apparatus”) as a reply for learning. As a result, for example, the learning unit 12 of the information processing apparatus 10A can learn the language model again based on combination data of the reference data and a reply with a higher reliability among the replies generated by the other information processing apparatuses 10.

In addition, for example, the specification unit 22 may specify the first reply among the third reply generated with the third reliability by the information processing apparatus 10B, the fourth reply generated with the fourth reliability by the information processing apparatus 10C, and a fifth reply generated with a fifth reliability by the information processing apparatus 10A. In this case, for example, the specification unit 22 may specify, as a reply to be used for learning, a reply with the highest total value of reliabilities for the same reply among the replies.

In this case, for example, it is assumed that a reply generated by the information processing apparatus 10B is the word “Sunday” and has a reliability score of 0.3. In addition, it is assumed that replies generated by the information processing apparatus 10C and the information processing apparatus 10A are the same word “Tuesday” and have reliability scores of 0.2 and 0.15, respectively. In this case, a total score for “Sunday” is 0.3, and a total score for “Tuesday” is 0.35 (=0.2+0.15). Therefore, “Tuesday” is specified as a reply to be used for learning. As a result, for example, the learning unit 12 of the information processing apparatus 10A can learn the language model again based on combination data of the reference data and a reply with the highest total value of reliabilities for the same reply among the replies generated by the other information processing apparatuses 10.

Next, the transmission unit 23 of the server 20 transmits the first reply specified by the specification unit 22 to each of the information processing apparatuses 10 (step S107-1 to 3). Next, the learning unit 12 of each of the information processing apparatuses 10 learns the language model again based on combination data of the reply received from the server 20 and the reference data (steps S108-1 to 3).

Here, for example, the learning unit 12 may assign different weights to a first model based on local data and a second model based on the reference data, and integrate the first model and the second model as the language model. As a result, for example, it is possible to generate the language model adapted to any one of the local data used by the information processing apparatus 10A and the reference data. In this case, for example, the learning unit 12 may calculate, as a value of each parameter of the language model, a value obtained by weighted-averaging a value of each parameter of a neural network or the like included in the first model and a value of each parameter in the second model.

In addition, the learning unit 12 may learn the language model based on, for example, learning data obtained by integrating the local data and the combination data of the reference data and the reply for learning specified by the server 20. In this case, for example, the learning unit 12 may perform self-supervised learning or semi-supervised learning using text data of a document included in the local data and text data obtained by combining the reply with the reference data as inputs. In this case, for example, the learning unit 12 may weight each of a loss function for the reference data and a loss function for the local data. In this case, for example, the learning unit 12 may set a weighting factor of the reference data to a first factor (for example, 0.2) and set a weighting factor of the local data to a second factor (for example, 0.8) larger than the first factor. As a result, for example, the local data is more emphasized in learning, so that the language model more suitable for the local data can be generated. Note that the information processing system 1 may repeatedly execute the processing from step S103 to step S107.

### Others

Federated learning is known as a method in which each of a plurality of clients learns a high-performance model in cooperation without disclosing his/her own data to the other clients. In the federated learning, parameters of models locally learned by the respective clients are transmitted to a server, and the models are aggregated (for example, parameter values are averaged) on the server side to integrate knowledge of the respective clients.

In a case where a language model is generated by the federated learning, there is a possibility that learning data used in the local learning of each of the clients is leaked from the parameters of the model locally learned by each of the clients. In addition, there is a possibility that learning data used in the local learning of each of the clients is leaked at the time of inference also from the model aggregated on the server side.

According to the present disclosure, in a case where a reply generated for reference data includes confidential information or the like, a client (the information processing apparatus 10) transmits, to the server 20, a concealed reply in which the confidential information or the like is concealed. Then, the client learns a language model using replies generated by other clients. As a result, for example, a plurality of clients can appropriately perform machine learning of the language model in cooperation while improving security (information leakage reduction) of local data.

### Modified Example

Each of the information processing apparatus 10 and the server 20 may be an apparatus contained in one housing, but each of the information processing apparatus 10 and the server 20 of the present disclosure is not limited thereto. Each unit of the information processing apparatus 10 and the server 20 may be implemented by, for example, cloud computing including one or more computers. In addition, the information processing apparatus 10 and the server 20 may be housed in the same housing and configured as an integrated information processing apparatus. Each of the information processing apparatus 10 and the server 20 as described above is also included in an example of each of the “information processing apparatus” and the “server” of the present disclosure.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Some or all of the above-described example embodiments may be described as in the following supplementary notes, but are not limited to the following supplementary notes. Note that some or all of the elements (for example, configurations and functions) described in each supplementary note dependent on Supplementary Note 1 can also be dependent on independent supplementary notes of other categories by the same dependency relationship. Some or all of the elements described in any supplementary note may be applied to various types of hardware, software, recording means for recording software, systems, and methods.

### Supplementary Note 1

An information processing apparatus including:
a learning unit configured to perform machine learning of a language model;
a generation unit configured to generate a reply to reference data received from a server using the language model; and
a concealment unit configured to transmit, to the server, a concealed reply in which information of a specific type in the reply is concealed,
wherein the learning unit learns the language model based on combination data of the reference data and replies generated for the reference data by other information processing apparatuses, the replies being received from the server.

### Supplementary Note 2

The information processing apparatus according to Supplementary Note 1, wherein
the generation unit generates a first reply having a first reliability and a second reply having a second reliability lower than the first reliability, and
the concealment unit determines the second reply as the concealed reply when the first reply includes information of the specific type and the second reply does not include information of the specific type.

### Supplementary Note 3

The information processing apparatus according to Supplementary Note 1 or 2, wherein the learning unit assigns different weights to a first model based on local data and a second model based on the reference data, and integrates the first model and the second model as the language model.

### Supplementary Note 4

The information processing apparatus according to any one of Supplementary Notes 1 to 3, wherein the learning unit learns the language model based on data for learning obtained by integrating local data and the combination data.

### Supplementary Note 5

The information processing apparatus according to any one of Supplementary Notes 1 to 4, wherein
the other information processing apparatuses include a first information processing apparatus and a second information processing apparatus, and
the learning unit learns the language model based on combination data of the reference data and a reply with the highest reliability out of a third reply generated with a third reliability by the first information processing apparatus and a fourth reply generated with a fourth reliability by the second information processing apparatus.

### Supplementary Note 6

The information processing apparatus according to any one of Supplementary Notes 1 to 5, wherein
the other information processing apparatuses include a first information processing apparatus and a second information processing apparatus, and
the learning unit learns the language model based on combination data of the reference data and a reply with a highest total value of reliabilities for an identical reply among a third reply generated with a third reliability by the first information processing apparatus, a fourth reply generated with a fourth reliability by the second information processing apparatus, and a fifth reply generated with a fifth reliability by the generation unit.

### Supplementary Note 7

An information processing method including:
performing machine learning of a language model;
generating a reply to reference data received from a server using the language model;
transmitting, to the server, a concealed reply in which information of a specific type in the reply is concealed; and
learning the language model based on combination data of the reference data and replies generated for the reference data by other information processing apparatuses, the replies being received from the server.

### Supplementary Note 8

A program for causing a computer to execute processing including:
performing machine learning of a language model;
generating a reply to reference data received from a server using the language model;
transmitting, to the server, a concealed reply in which information of a specific type in the reply is concealed; and
learning the language model based on combination data of the reference data and replies generated for the reference data by other information processing apparatuses, the replies being received from the server.

### Supplementary Note 9

A server including:
a transmission unit configured to transmit reference data to a plurality of information processing apparatuses;
an acquisition unit configured to acquire, from each of the plurality of information processing apparatuses, a reply to the reference data or a concealed reply in which information of a specific type in the reply is concealed, the reply being generated using a machine-learned language model; and
a specification unit configured to specify a first reply among a plurality of the replies acquired by the acquisition unit,
wherein the transmission unit transmits information for learning of the language model to the plurality of information processing apparatuses based on combination data of the first reply and the reference data.

### Supplementary Note 10

An information processing method including:
transmitting reference data to a plurality of information processing apparatuses;
acquiring, from each of the plurality of information processing apparatuses, a reply to the reference data or a concealed reply in which information of a specific type in the reply is concealed, the reply being generated using a machine-learned language model;
specifying a first reply among a plurality of the acquired replies; and
transmitting information for learning of the language model to the plurality of information processing apparatuses based on combination data of the first reply and the reference data.

### Supplementary Note 11

A program for causing a computer to execute processing including:
transmitting reference data to a plurality of information processing apparatuses;
acquiring, from each of the plurality of information processing apparatuses, a reply to the reference data or a concealed reply in which information of a specific type in the reply is concealed, the reply being generated using a machine-learned language model;
specifying a first reply among a plurality of the acquired replies; and
transmitting information for learning of the language model to the plurality of information processing apparatuses based on combination data of the first reply and the reference data.

### Supplementary Note 12

An information processing system including
a server and a plurality of information processing apparatuses,
wherein each of the plurality of information processing apparatuses includes:
a learning unit configured to perform machine learning of a language model;
a generation unit configured to generate a reply to reference data received from the server using the language model; and
a concealment unit configured to transmit, to the server, a concealed reply in which information of a specific type in the reply is concealed,
the learning unit learns the language model based on combination data of the reference data and replies generated for the reference data by the other information processing apparatuses, the replies being received from the server,
the server includes:
a transmission unit configured to transmit the reference data to the plurality of information processing apparatuses;
an acquisition unit configured to acquire, from each of the plurality of information processing apparatuses, the reply to the reference data or the concealed reply in which the information of the specific type in the reply is concealed, the reply being generated using the machine-learned language model; and
a specification unit configured to specify a first reply among a plurality of the replies acquired by the acquisition unit, and
the transmission unit transmits information for learning of the language model to the plurality of information processing apparatuses based on combination data of the first reply and the reference data.

### Supplementary Note 13

An information processing method including:
performing, by an information processing apparatus, machine learning of a language model;
generating, by the information processing apparatus, a reply to reference data received from a server using the language model;
transmitting, by the information processing apparatus, a concealed reply in which information of a specific type in the reply is concealed to the server;
learning, by the information processing apparatus, the language model based on combination data of the reference data and replies generated for the reference data by other information processing apparatuses, the replies being received from the server;
transmitting, by the server, the reference data to a plurality of the information processing apparatuses;
acquiring, by the server, the reply to the reference data generated using the machine-learned language model or the concealed reply in which the information of the specific type in the reply is concealed from each of the plurality of information processing apparatuses;
specifying, by the server, a first reply among a plurality of the acquired replies; and
transmitting, by the server, information for learning of the language model to the plurality of information processing apparatuses based on combination data of the first reply and the reference data.

What is claimed is:

1. An information processing apparatus comprising:
at least one memory storing instructions, and
at least one processor configured to execute the instructions to;
perform machine learning of a language model;
generate a reply to reference data received from a server using the language model; and
transmit, to the server, a concealed reply in which information of a specific type in the reply is concealed,
wherein the at least one processor configured to learn the language model based on combination data of the reference data and replies generated for the reference data by other information processing apparatuses, the replies being received from the server.

2. The information processing apparatus according to claim 1, wherein
the at least one processor configured to generate a first reply having a first reliability and a second reply having a second reliability lower than the first reliability, and
the at least one processor configured to determine the second reply as the concealed reply when the first reply includes information of the specific type and the second reply does not include information of the specific type.

3. The information processing apparatus according to claim 1, wherein the at least one processor configured to assign different weights to a first model based on local data and a second model based on the reference data, and integrates the first model and the second model as the language model.

4. The information processing apparatus according to claim 1, wherein the at least one processor configured to learn the language model based on data for learning obtained by integrating local data and the combination data.

5. The information processing apparatus according to claim 1, wherein
the other information processing apparatuses include a first information processing apparatus and a second information processing apparatus, and
the at least one processor configured to learn the language model based on combination data of the reference data and a reply with a highest reliability out of a third reply generated with a third reliability by the first information processing apparatus and a fourth reply generated with a fourth reliability by the second information processing apparatus.

6. The information processing apparatus according to claim 1, wherein
the other information processing apparatuses include a first information processing apparatus and a second information processing apparatus, and
the at least one processor configured to learn the language model based on combination data of the reference data and a reply with a highest total value of reliabilities for an identical reply among a third reply generated with a third reliability by the first information processing apparatus, a fourth reply generated with a fourth reliability by the second information processing apparatus, and a fifth reply generated with a fifth reliability by the at least one processor.

7. An information processing method comprising:
performing machine learning of a language model;
generating a reply to reference data received from a server using the language model;
transmitting, to the server, a concealed reply in which information of a specific type in the reply is concealed; and
learning the language model based on combination data of the reference data and replies generated for the reference data by other information processing apparatuses, the replies being received from the server.

8. A server comprising:
at least one memory storing instructions, and
at least one processor configured to execute the instructions to;
transmit reference data to a plurality of information processing apparatuses;
acquire, from each of the plurality of information processing apparatuses, a reply to the reference data or a concealed reply in which information of a specific type in the reply is concealed, the reply being generated using a machine-learned language model; and
specify a first reply among a plurality of the acquired replies,
wherein the at least one processor configured to transmit information for learning of the language model to the plurality of information processing apparatuses based on combination data of the first reply and the reference data.
